(19) United States
(12) Patent Application Publication
(10) Pub. No.: US 2010/0265934 A1
(43) Pub. Date: Oct. 21, 2010

(54) METHODS AND SYSTEMS USING FAST INITIAL SYNCHRONIZATION FOR WIMAX MOBILE STATIONS

(75) Inventors: Chun Woo Lee, San Ramon, CA (US); Remi Gurski, San Diego, CA (US); Steven Cheng, San Diego, CA (US); Patrick Lim, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/425,539

(22) Filed: Apr. 17, 2009

(51) Int. Cl. H04J 3/06

(52) U.S. Cl. 370/350

(57) ABSTRACT

Certain embodiments of the present disclosure provide techniques for bypassing the DCD/UCD message reception step in the network entry procedure in WiMAX systems by using DCD/UCD messages that are stored in a nonvolatile memory inside a mobile station.

### TECHNICAL FIELD

Certain embodiments of the present disclosure generally relate to wireless communication and, more particularly, to a technique for fast initial synchronization.

### SUMMARY

Certain embodiments provide a method for wireless communications. The method generally includes receiving one or more channel descriptor (CD) messages from a base station, the CD messages comprising at least one of a downlink channel descriptor (DCD) message and an uplink channel descriptor (UCD) message and storing the received CD messages in memory and receiving one or more access definition messages from a base station after powering up from a powered down state, the access definition messages comprising at least one of a downlink access definition (DL-MAP) message and an uplink access definition (UL-MAP) message and searching the memory to find a match between a count field in the access definition messages and stored CD messages and performing an initial ranging procedure using information in the stored CD messages if a match is found or waiting to receive new CD messages before starting the initial ranging procedure if a match is not found.

Certain embodiments provide an apparatus for wireless communications. The apparatus generally includes logic for receiving one or more channel descriptor (CD) messages from a base station, the CD messages comprising at least one of a downlink channel descriptor (DCD) message and an uplink channel descriptor (UCD) message logic for storing the received CD messages in memory logic for receiving one or more access definition messages from a base station after powering up from a powered down state, the access definition messages comprising at least one of a downlink access definition (DL-MAP) message and an uplink access definition (UL-MAP) message logic for searching the memory to find a match between a count field in the access definition messages and stored CD messages and logic for performing an initial ranging procedure using information in the stored CD messages if a match is found or logic for waiting to receive new CD messages before starting the initial ranging procedure if a match is not found.

Certain embodiments provide an apparatus for wireless communications. The apparatus generally includes means for receiving one or more channel descriptor (CD) messages from a base station, the CD messages comprising at least one of a downlink channel descriptor (DCD) message and an uplink channel descriptor (UCD) message means for storing the received CD messages in memory means for receiving one or more access definition messages from a base station after powering up from a powered down state, the access definition messages comprising at least one of a downlink access definition (DL-MAP) message and an uplink access definition (UL-MAP) message means for searching the memory to find a match between a count field in the access definition messages and stored CD messages and means for performing an initial ranging procedure using information in the stored CD messages if a match is found or means for waiting to receive new CD messages before starting the initial ranging procedure if a match is not found.

Certain embodiments provide a computer-program product for wireless communications, comprising a computer readable medium having instructions stored thereon, the instructions being executable by one or more processors. The instructions generally include instructions for receiving one or more channel descriptor (CD) messages from a base station, the CD messages comprising at least one of a downlink channel descriptor (DCD) message and an uplink channel descriptor (UCD) message instructions for storing the received CD messages in memory instructions for receiving one or more access definition messages from a base station after powering up from a powered down state, the access definition messages comprising at least one of a downlink access definition (DL-MAP) message and an uplink access definition (UL-MAP) message instructions for searching the memory to find a match between a count field in the access definition messages and stored CD messages and instructions for performing an initial ranging procedure using information in the stored CD messages if a match is found or instructions for waiting to receive new CD messages before starting the initial ranging procedure if a match is not found.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates the downlink/uplink channel descriptor (DCD/UCD) messages that are transmitted in Worldwide Interoperability for Microwave Access (WiMAX) standard.

FIG. 5 illustrates example operations for a fast initial synchronization method for a mobile station using WiMAX standard in accordance with certain embodiments of the present disclosure.

FIG. 5A illustrates example components capable of performing the operations illustrated in FIG. 5.

FIG. 6 illustrates example operations for a fast synchronization method for a WiMAX mobile station after powering up in accordance with certain embodiments of the present disclosure.

FIG. 6A illustrates example components capable of performing the operations illustrated in FIG. 6.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

A Mobile Station (MS) utilizing the Institute of Electrical and Electronics Engineers (IEEE) 802.16 standard obtains network parameters by receiving both downlink channel descriptor (DCD) and uplink channel descriptor (UCD) messages from a base station (BS) before being able to start an Initial Ranging procedure. However, the IEEE 802.16 standard allows a BS to transmit DCD and UCD messages every 10 seconds to reduce the amount of control overhead. Therefore, in the worst case, the first step of the network entry procedure (i.e., obtaining the network parameters) may take up to 10 seconds.

As a result, the time spent waiting to receive the DCD and UCD messages may be longer than the total time spent on all the other steps of the network entry procedure.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

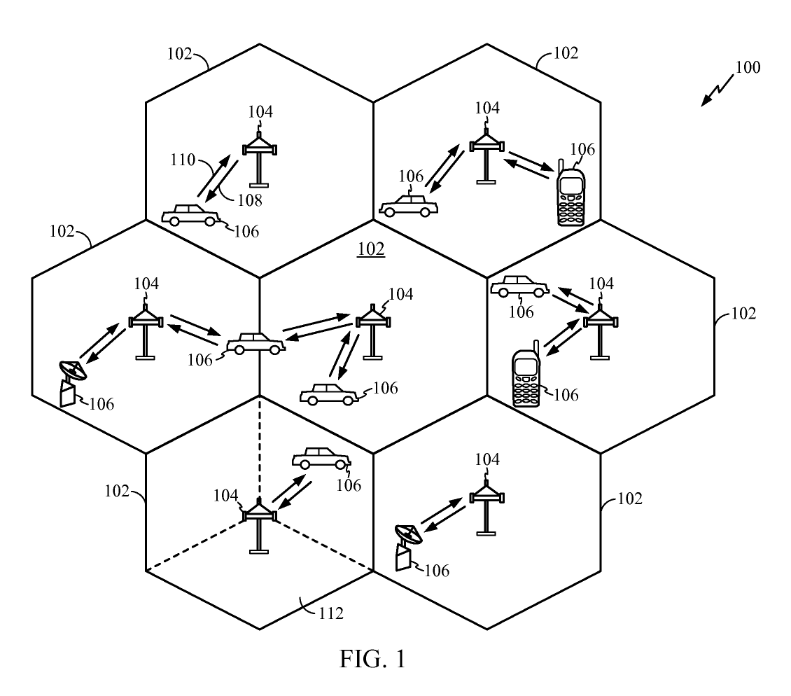

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

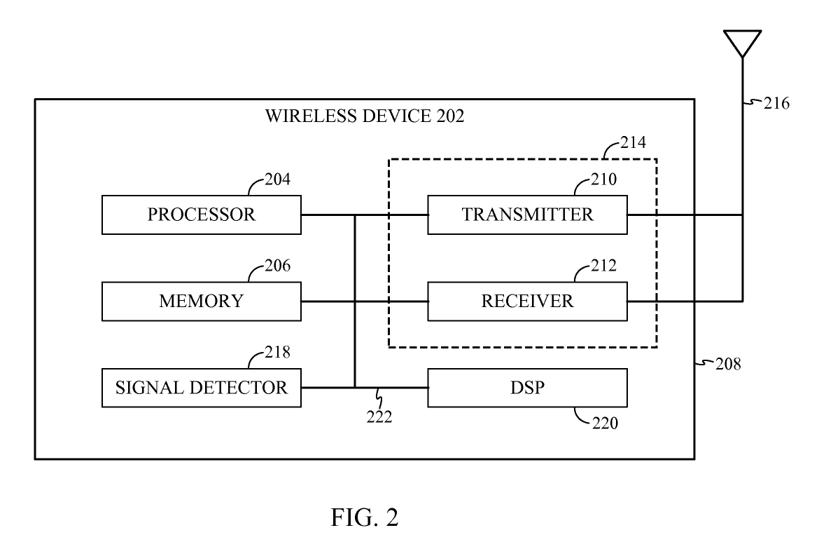

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

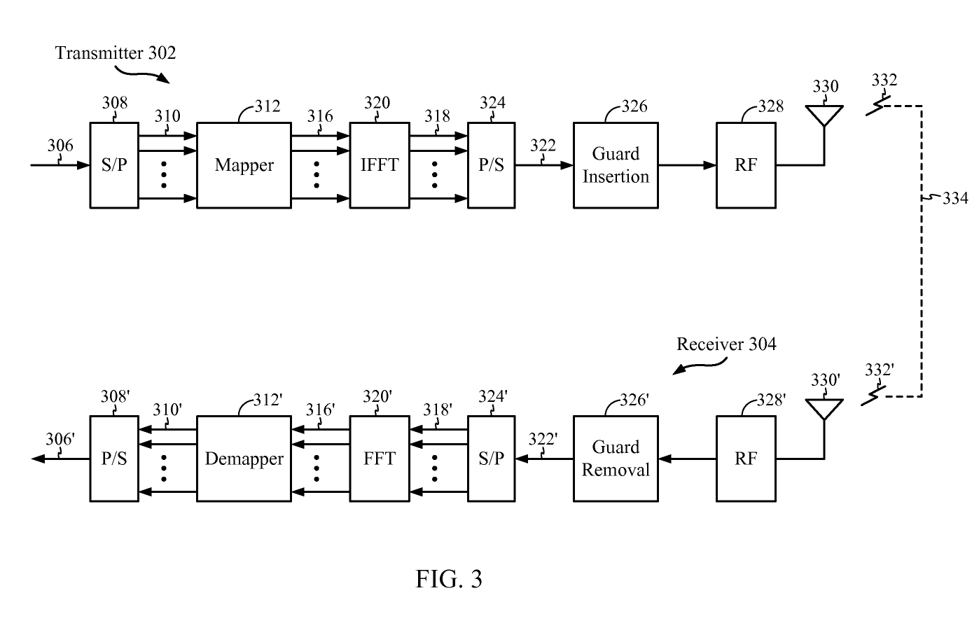

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to Nₑₚ (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Fast Initial Synchronization for WiMAX Mobile Stations

In WiMAX systems, the base station (BS) broadcasts downlink channel descriptor (DCD) and uplink channel descriptor (UCD) messages periodically. During the first two steps of the network entry procedure, a mobile station (MS) should receive both DCD and UCD messages. The transmission of DCD/UCD messages may be suspended for up to 10 seconds to reduce the amount of control overhead. Therefore, in a worst-case scenario, the first step of the network entry procedure (i.e., obtaining network parameters) may take up to 10 seconds. The time spent waiting to receive DCD and UCD messages may be longer than the total time spent on all the other steps of the network entry procedure.

Both DCD and UCD messages have Configuration Change Count (CCC) fields that are used to indicate different versions of the DCD/UCD messages. The downlink access definition (DL-MAP) and uplink access definition (UL-MAP) messages also contain copies of the current CCC fields of the corresponding DCD/UCD messages. The DL-MAP/UL-MAP messages are transmitted with every OFDM frame, which is much more frequent than the transmission of DCD/UCD messages. After receiving a DL-MAP/UL-MAP message, the mobile station uses one of the recent DCD/UCD messages with a CCC field that matches the CCC field of the current DL-MAP/UL-MAP messages to decode the information inside the frame.

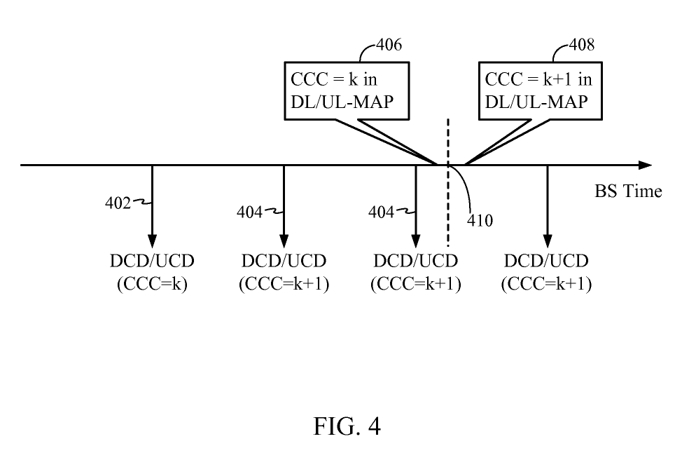

In an effort to ensure MSs have the latest versions of DCD/UCD messages before they go into effect, a BS is typically required to broadcast a new version of DCD and/or UCD before the new version becomes effective. FIG. 4 illustrates DCD/UCD messages transmitted by the base station in case of a value change. At 402, a DCD/UCD messages with CCC=k are transmitted from the base station. The corresponding CCC fields in DL-MAP/UL-MAP messages 406 are equal to k. When DCD/UCD messages are changed, new versions with CCC=k+1 404 are transmitted from the BS before the change becomes effective at 408.

The present disclosure provided techniques for bypassing the DCD/UCD message reception step in the network entry procedure by using DCD/UCD messages that are stored in a nonvolatile memory inside a mobile station. For certain embodiments, a mobile station may keep copies of the latest DCD/UCD messages for a plurality of base stations and store them into a nonvolatile memory periodically. For certain embodiments, the MS may store copies of the latest DCD/UCD messages when the system is powering down.

For certain embodiments of the present disclosure, during the power-up procedure, when an MS receives a Downlink/Uplink Access Definition (DL-MAP/UL-MAP) message, the MS may search in the stored table of DCD/UCD messages to find a match for that BS. If the configuration change count (CCC) field in DL-MAP/UL-MAP message matches with the CCC field in the stored DCD/UCD message for the serving BS, the MS may bypass waiting to receive a new DCD/UCD message and may use the information inside the DCD/UCD message that is stored in the memory to initiate a ranging procedure.

In case stored DCD/UCD messages were used for network entry, when the MS receives DCD/UCD messages from the serving BS later, the MS may compare whole contents of the received messages with the stored messages to confirm that the MS is relying on the correct information. If they are not the same, the MS may take actions, such as: 1) restarting the network entry process if the difference is found in a critical area or 2) overwriting stored CDs with the received CDs and continue communication if the difference is found in an ignorable area. These actions may be needed because the CCC value is in a cyclic 8-bit range, although the possibility of an issue may be extremely low.

Probability of a match between the CCC field in the DL-MAP/UL-MAP message and a CCC field in the stored DCD/UCD message may be relatively high, because contents of DCD/UCD messages change relatively infrequently.

Network entry procedure for a mobile station under WiMAX standard includes several steps. These steps generally include scanning the DL channel and establishing synchronization with a BS, obtaining UL parameters from a UCD message, performing ranging, negotiating basic capabilities, authorizing the MS and performing key exchange, registering with the BS, establishing IP connectivity and time of day, transferring operational parameters and setting up connections between the MS and the BS.

When an MS receives a DL-MAP message, the MS may use the CCC field inside the DL-MAP message to search for the matching DCD information in its memory. If the MS is unable to find a matching DCD message, the MS may not be able to decode most of the DL data bursts described by the DL-MAP message. Similarly, if the MS receives a UL-MAP message and is not able to find a matching UCD message in its memory, the MS may not be able to send initial ranging CDMA code. Therefore, the MS has to receive both DCD and UCD messages before starting the initial ranging procedure.

During normal operations, an MS may receive the DCD/UCD messages of the neighboring base stations in addition to the DCD/UCD messages of the serving base station through over-the-air transmissions of a mobile neighbor advertisement message (MOB_NBR-ADV). When an MS receives a DCD/UCD message with an updated configuration change count field, the MS may store a copy of the message into the DCD/UCD table of that particular base station.

MS may maintain a plurality of DCD tables, each of which may be dedicated to one neighboring base station. Each DCD table may contain multiple entries of the DCD messages with different configuration change count fields. A similar method is applicable to the UCD message.

For certain embodiments of the present disclosure, during the power down procedure, an MS may save the latest DCD/UCD messages for all the neighboring base stations into a nonvolatile memory. For another embodiment, the MS may also save the DCD/UCD information into the nonvolatile memory during normal operation to be prepared for an unexpected power failure.

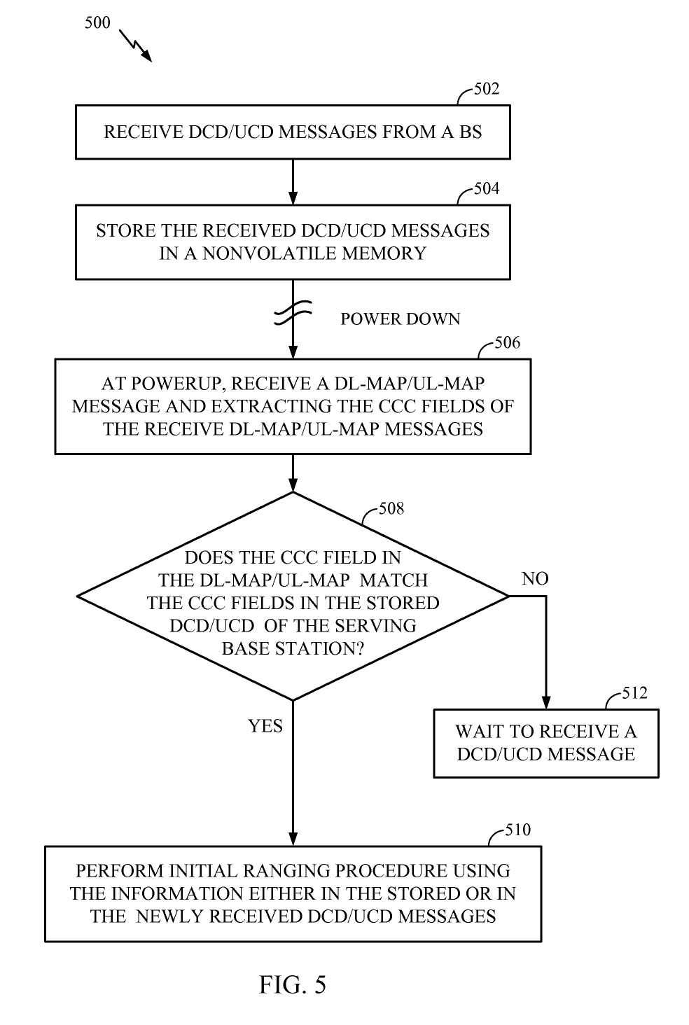

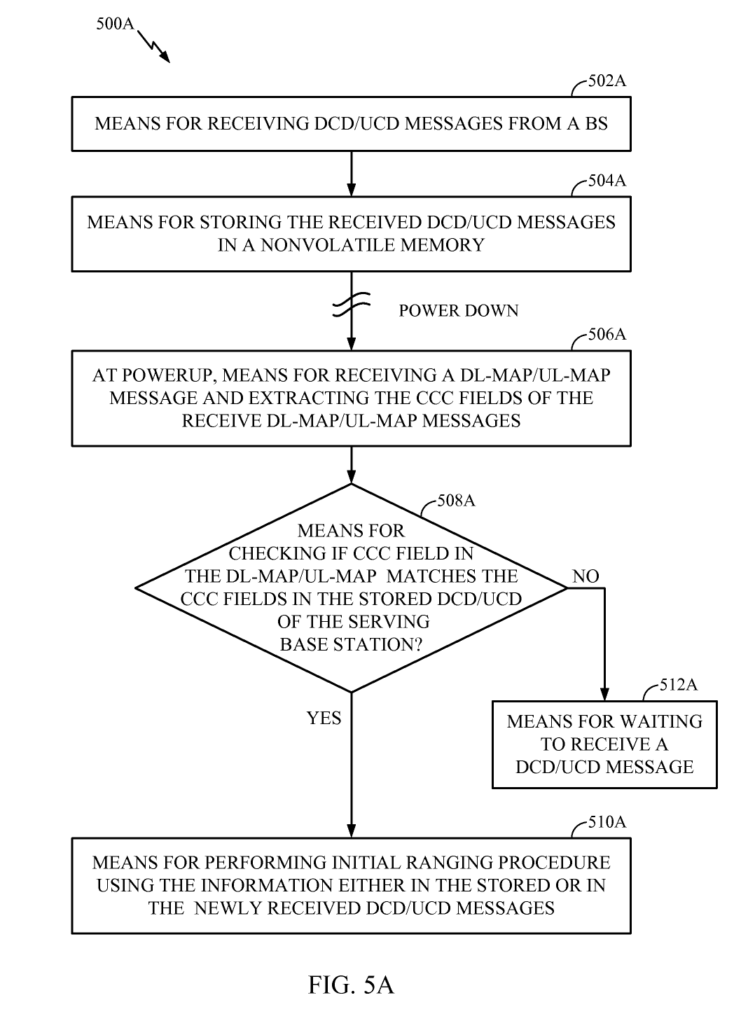

FIG. 5 illustrates example operations for a fast initial synchronization method for a mobile station using WiMAX standard in accordance with certain embodiments of the present disclosure. At 502, the MS may receive a downlink channel descriptor (DCD) message. At 504, the MS may store the received DCD message into a nonvolatile memory. The MS may subsequently be powered down for some amount of time. At 506, after the MS is powered up (after being powered down), it may receive an OFDM frame containing DL-MAP message that includes information about the network. The MS extracts the CCC field of the received DL-MAP message.

At 508, the MS may check to see if the CCC field in the DL-MAP message matches any of the entries of the DCD table corresponding to the serving base station. If there is a match, the MS may use the information in the stored DCD message in the next step of the network entry procedure. At 512, if there is not any match between the CCC field in the DCD messages and DL-MAP message, the MS may continue to wait to receive valid DCD messages from the serving base station.

After finding a valid DCD message for the serving base station, the MS performs a similar procedure for the UCD messages and compares the CCC fields in stored UCD tables with the CCC fields in the UL-MAP messages received from the serving base station to find a valid UCD message. At 510, The MS may start the initial ranging procedure when it has a valid DCD message and a valid UCD message for the serving base station.

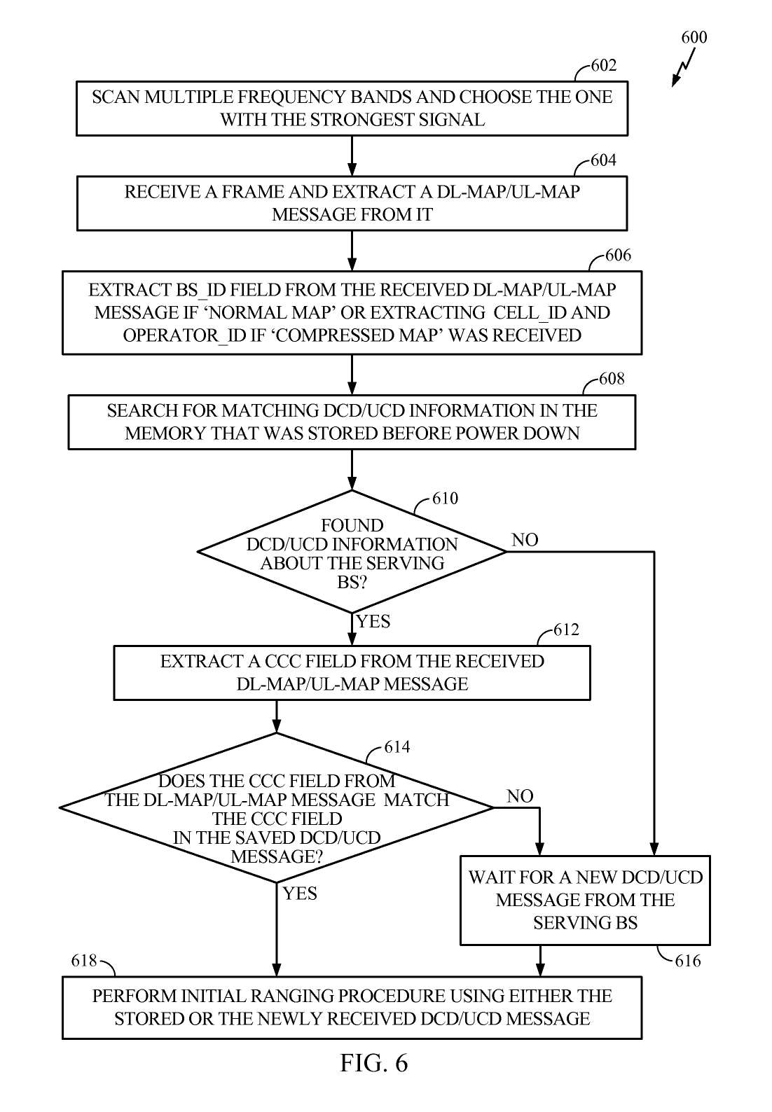

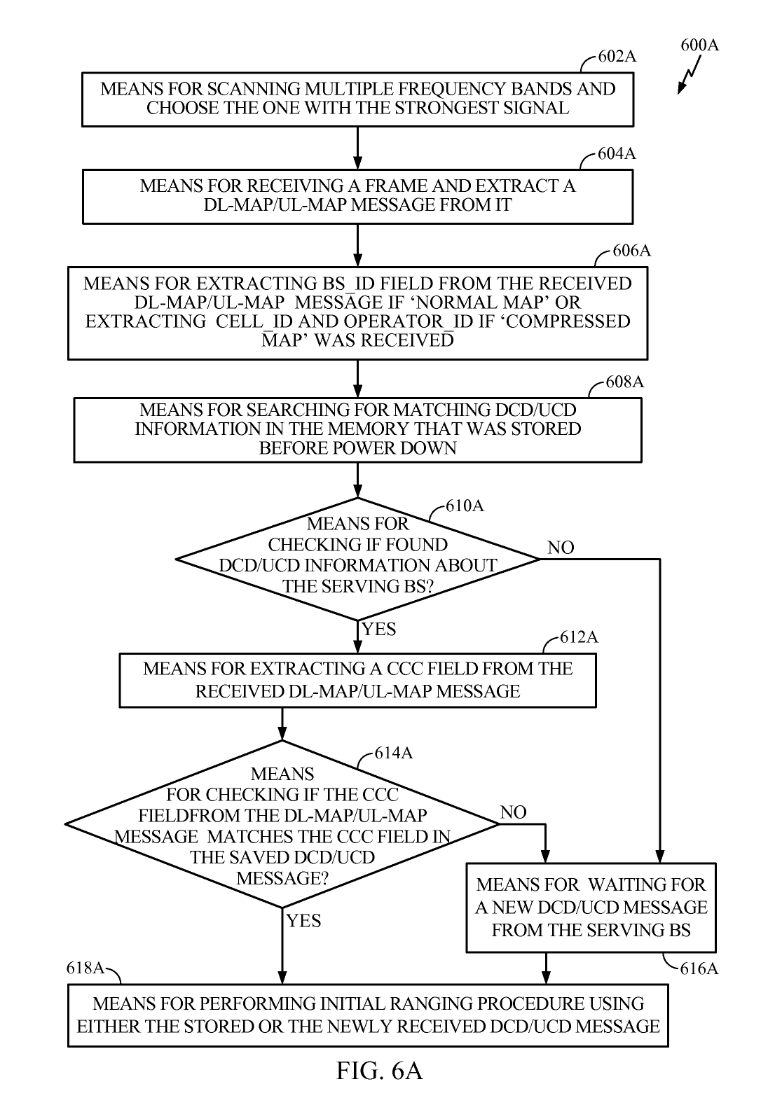

FIG. 6 illustrates example operations for a fast synchronization method for a WiMAX mobile station after powering up in accordance with certain embodiments of the present disclosure. When a mobile station is powered up, at 602, the MS may scan a plurality of frequency bands and choose a frequency band with the strongest signal. At 604, the MS receives WiMAX frames and extracts DL-MAP/UL-MAP messages from the received frames. At 606, the MS extracts information about the transmitting BS (i.e., BS_ID) from the DL_MAP/UL-MAP messages if the BS has transmitted ‘Normal MAP’ messages. For certain embodiments, if the BS has transmitted ‘Compressed MAP’ messages, the MS may extract the Cell_ID and the Operator_ID fields from the DL-MAP/UL-MAP messages instead of the BS_ID.

At 608, the MS may search the DCD/UCD tables in the memory and may find a matching BS_ID or Cell/Operator_ID in one of the DCD/UCD entries that was stored before power down. At 610, if the MS finds stored DCD/UCD messages from the serving BS, at 612, the MS may extract CCC fields from the DL-MAP/UL-MAP messages that contain versions of the corresponding DCD/UCD messages. At 614, if the CCC fields from the stored DCD/UCD messages match the CCC fields from DL-MAP/UL-MAP messages, the MS starts the initial ranging procedure (618) using the information in the stored DCD/UCD messages. If the MS is unable to find matching DCD/UCD messages in the stored tables, the MS waits to receive valid DCD/UCD messages from the serving BS over the air before starting the initial ranging procedure. Note that the MS should have a valid DCD message and a valid UCD message before being able to start the initial ranging procedure.

A mobile station may reduce the time spent on the network entry procedure significantly by utilizing the method proposed in this disclosure. The proposed method may not require any changes in WiMAX standard.

The various operations of methods described above may be performed by various hardware and/or software component(s) and/or module(s) corresponding to means-plus-function blocks illustrated in the Figures. For example, blocks 602-618 illustrated in FIG. 5 correspond to means-plus-function blocks 502A-512A illustrated in FIG. 5A. Also, blocks 602-618 illustrated in FIG. 6 correspond to means-plus-function blocks 602A-618A illustrated in FIG. 6A. More generally, where there are methods illustrated in Figures having corresponding counterpart means-plus-function Figures, the operation blocks correspond to means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications comprising:
receiving one or more channel descriptor (CD) messages from a base station, the CD messages comprising at least one of a downlink channel descriptor (DCD) message and an uplink channel descriptor (UCD) message;
storing the received CD messages in memory;
receiving one or more access definition messages from a base station after powering up from a powered down state, the access definition messages comprising at least one of a downlink access definition (DL-MAP) message and an uplink access definition (UL-MAP) message;
searching the memory to find a match between a count field in the access definition messages and stored CD messages; and
performing an initial ranging procedure using information in the stored CD messages if a match is found or waiting to receive new CD messages before starting the initial ranging procedure if a match is not found.

2. The method of claim 1, wherein the memory comprises nonvolatile memory.

3. The method of claim 1, wherein CD messages corresponding to different base stations are stored in the memory.

4. The method of claim 1, wherein the memory is updated when new CD messages are received.

5. The method of claim 1, wherein the memory is updated before entering the power down state.

6. The method of claim 1, wherein searching the memory to find a match comprises:
extracting identification information about the serving base station from at least one of a DL_MAP message and a UL_MAP message;
searching the memory for information about the serving base station to find a matching CD message comprising at least one of a DCD message and a UCD message with matching identification information; and
determining if a configuration change count (CCC) field from the matching CD message matches a CCC field from the at least one of a DL_MAP message and a UL_MAP message.

7. The method of claim 1, further comprising:
comparing contents of stored CD messages to contents of later received CD messages; and
restarting network entry if the contents do not match.

8. The method of claim 1, further comprising:
storing at least one of DCD and UCD information of one or more neighbor base stations received in a mobile neighbor advertisement (MOB_NBR-ADV) message from a serving base station.

9. An apparatus for wireless communications comprising:
logic for receiving one or more channel descriptor (CD) messages from a base station, the CD messages comprising at least one of a downlink channel descriptor (DCD) message and an uplink channel descriptor (UCD) message;
logic for storing the received CD messages in memory;
logic for receiving one or more access definition messages from a base station after powering up from a powered down state, the access definition messages comprising at least one of a downlink access definition (DL-MAP) message and an uplink access definition (UL-MAP) message;
logic for searching the memory to find a match between a count field in the access definition messages and stored CD messages; and
logic for performing an initial ranging procedure using information in the stored CD messages if a match is found or logic for waiting to receive new CD messages before starting the initial ranging procedure if a match is not found.

10. The apparatus of claim 9, wherein the memory comprises nonvolatile memory.

11. The apparatus of claim 9, wherein CD messages corresponding to different base stations are stored in the memory.

12. The apparatus of claim 9, wherein the memory is updated when new CD messages are received.

13. The apparatus of claim 9, wherein the memory is updated before entering the power down state.

14. The apparatus of claim 9, wherein logic for searching the memory to find a match comprises:
logic for extracting identification information about the serving base station from at least one of a DL_MAP message and a UL_MAP message;
logic for searching the memory for information about the serving base station to find a matching CD message comprising at least one of a DCD message and a UCD message with matching identification information; and
logic for determining if a configuration change count (CCC) field from the matching CD message matches a CCC field from the at least one of a DL_MAP message and a UL_MAP message.

15. The apparatus of claim 9, further comprising:
logic for comparing contents of stored CD messages to contents of later received CD messages; and
logic for restarting network entry if the contents do not match.

16. The apparatus of claim 9, further comprising:
logic for storing at least one of DCD and UCD information of one or more neighbor base stations received in a mobile neighbor advertisement (MOB_NBR-ADV) message from a serving base station.

17. An apparatus for wireless communications comprising:
means for receiving one or more channel descriptor (CD) messages from a base station, the CD messages comprising at least one of a downlink channel descriptor (DCD) message and an uplink channel descriptor (UCD) message;
means for storing the received CD messages in memory;
means for receiving one or more access definition messages from a base station after powering up from a powered down state, the access definition messages comprising at least one of a downlink access definition (DL-MAP) message and an uplink access definition (UL-MAP) message;
means for searching the memory to find a match between a count field in the access definition messages and stored CD messages; and
means for performing an initial ranging procedure using information in the stored CD messages if a match is found or means for waiting to receive new CD messages before starting the initial ranging procedure if a match is not found.

18. The apparatus of claim 17, wherein the memory comprises nonvolatile memory.

19. The apparatus of claim 17, wherein CD messages corresponding to different base stations are stored in the memory.

20. The apparatus of claim 17, wherein the memory is updated when new CD messages are received.

21. The apparatus of claim 17, wherein the memory is updated before entering the power down state.

22. The apparatus of claim 17, wherein means for searching the memory to find a match comprises:
means for extracting identification information about the serving base station from at least one of a DL_MAP message and a UL_MAP message;
means for searching the memory for information about the serving base station to find a matching CD message comprising at least one of a DCD message and a UCD message with matching identification information; and
means for determining if a configuration change count (CCC) field from the matching CD message matches a CCC field from the at least one of a DL_MAP message and a UL_MAP message.

23. The apparatus of claim 17, further comprising:
means for comparing contents of stored CD messages to contents of later received CD messages; and
means for restarting network entry if the contents do not match.

24. The apparatus of claim 17, further comprising:
means for storing at least one of DCD and UCD information of one or more neighbor base stations received in a mobile neighbor advertisement (MOB_NBR-ADV) message from a serving base station.

25. A computer-program product for wireless communications, comprising a computer readable medium having instructions stored thereon, the instructions being executable by one or more processors and the instructions comprising:
instructions for receiving one or more channel descriptor (CD) messages from a base station, the CD messages comprising at least one of a downlink channel descriptor (DCD) message and an uplink channel descriptor (UCD) message;
instructions for storing the received CD messages in memory;
instructions for receiving one or more access definition messages from a base station after powering up from a powered down state, the access definition messages comprising at least one of a downlink access definition (DL-MAP) message and an uplink access definition (UL-MAP) message;
instructions for searching the memory to find a match between a count field in the access definition messages and stored CD messages; and
instructions for performing an initial ranging procedure using information in the stored CD messages if a match is found or instructions for waiting to receive new CD messages before starting the initial ranging procedure if a match is not found.

26. The computer-program product of claim 25, wherein the memory comprises nonvolatile memory.

27. The computer-program product of claim 25, wherein CD messages corresponding to different base stations are stored in the memory.

28. The computer-program product of claim 25, wherein the memory is updated when new CD messages are received.

29. The computer-program product of claim 25, wherein the memory is updated before entering the power down state.

30. The computer-program product of claim 25, wherein the instructions for searching the memory to find a match comprises:
instructions for extracting identification information about the serving base station from at least one of a DL_MAP message and a UL_MAP message;
instructions for searching the memory for information about the serving base station to find a matching CD message comprising at least one of a DCD message and a UCD message with matching identification information; and
instructions for determining if a configuration change count (CCC) field from the matching CD message matches a CCC field from the at least one of a DL_MAP message and a UL_MAP message.

31. The computer-program product of claim 25, further comprising:
instructions for comparing contents of stored CD messages to contents of later received CD messages; and
instructions for restarting network entry if the contents do not match.

32. The computer-program product of claim 25, further comprising:
instructions for storing at least one of DCD and UCD information of one or more neighbor base stations received in a mobile neighbor advertisement (MOB_NBR-ADV) message from a serving base station.
